(19) United States
(12) Patent Application Publication
(10) Pub. No.: US 2014/0353915 A1
(43) Pub. Date: Dec. 4, 2014

(54) SEALING ARRANGMENT AND METHOD FOR THE PRODUCTION THEREOF

(71) Applicant: Trelleborg Sealing Solutions Germany GmbH, Stuttgart (DE)

(72) Inventor: Holger Jordan, Neuhausen a.d.F. (DE)

(21) Appl. No.: 14/463,327

(22) Filed: Aug. 19, 2014

Related U.S. Application Data
(63) Continuation of application No. PCT/EP2013/052850, filed on Feb. 13, 2013.

(30) Foreign Application Priority Data
Feb. 20, 2012 (DE) 10 2012 202 571.5

(51) Int. Cl. F16J 15/32

(52) U.S. Cl. CPC F16J 15/3204
USPC 277/309; 277/572

(57) ABSTRACT

A seal arrangement includes two machine components which are arranged so as to be able to be moved relative to each other along/about a movement axis, and having at least one resiliently deformable seal which is retained in a press-fitting manner on a seal retention structure on one of the two machine components. The seal forms a sliding guide for the two machine components, and has at least one sealing lip which is in sealing abutment with the other machine component in each case and which extends in an axial direction away from the seal retention structure. A free end portion of the sealing lip is supported by means of at least one resiliently deformable pretensioning element on one machine component in such a manner that the free end portion is in abutment with the other machine component with a defined contact pressure.

### CROSS-REFERENCE TO RELATED APPLICATIONS

This continuation application claims priority to PCT/EP2013/052850 filed on Feb. 13, 2013 which has published as WO 2013/124192 A1 and also the German application number 10 2012 202 571.5 filed on Feb. 20, 2012, the contents of which are fully incorporated herein with these references.

### DESCRIPTION

1. Field of the Invention

The invention relates to a seal arrangement having two machine components which are arranged so as to be able to be moved relative to each other along and/or about a movement axis, and having at least one resiliently deformable seal which is retained in a press-fitting manner on a seal retention structure on one of the two machine components, the seal forming a sliding guide for the two machine components. The seal has at least one sealing lip which is in sealing abutment with the other machine component in each case and which extends in an axial direction away from the seal retention structure.

### BACKGROUND OF THE INVENTION

Such a seal arrangement, as known, for example, from DE 195 13 727 A1, often has only an unsatisfactory sealing action during use. When such seal arrangements are used in environments with a very high degree of contamination, for example, when used in a shock-absorber, a hammer drill or the like, additional sealing components or wiping elements are therefore often required in order to seal the sliding guide in an adequate manner and to counteract excessive wear of the seal arrangement. This is costly and has little advantage in terms of technical production-related aspects.

An object of the present invention is to develop a seal arrangement of the type mentioned in the introduction in such a manner that it has an improved sealing action and less tendency to become worn. An object of the invention is further to set out a method for producing such a seal arrangement.

This object is achieved according to the invention by a seal arrangement having the features set out in the patent claims. The object relating to the production method is solved by a production method having the features set out in patent method claims.

### SUMMARY OF THE INVENTION

The advantage connected with the seal arrangement according to the invention substantially involves an improved sealing function of the sealing lip. The free end portion of the sealing lip is supported in a resilient manner by means of the pretensioning element on one machine component and is pressed by the pretensioning element with a defined, that is to say, freely predeterminable, contact pressure against the other machine element, that is to say, the sealing face thereof. Consequently, even during use in highly contaminated environments, there is a clearly reduced introduction of contamination, such as, for example, particles of dirt, and/or an operating fluid in the region of the sliding guide. Furthermore, a discharge of lubricant which is arranged in the region of the sliding guide, that is to say, in the sealing gap which is intended to be sealed between the two machine components, for example, lubricating oil, is counter-acted in a more reliable manner. This applies to translatory and/or rotary movements of the two machine components with respect to each other. On the whole, the required maintenance intervals of the seal arrangement can thereby be extended and the service-lives of the seal arrangement can be increased as a whole. Furthermore, with the seal arrangement according to the invention, additional sealing and/or wiping elements to protect the sliding guide formed by the seal, in particular from abrasive particles of dirt or the like, are required only in exceptional cases or are completely superfluous. This enables a structurally more simple and more compact structure of the seal arrangement. This on the whole affords economic advantages.

The seal is retained on one machine component with radial and/or axial press-fitting and may be constructed as an inner or an outer seal. In the case of an inner seal, the seal is surrounded in an at least partially peripheral manner by one machine component which is constructed, for example, as a cylinder. If the seal is constructed as an outer seal, it surrounds one machine component, for example, a piston, at the peripheral side. This embodiment is preferred in the case of high demands in terms of the transverse stability of the seal and the sliding guide which is formed thereby. On the whole, a particularly good range of uses of the seal arrangement is thereby enabled.

According to a preferred development of the invention, the seal covers the seal retention structure in a radial direction and is preferably in direct abutment therewith. The sliding guide for both machine components can thereby be constructed in this region in a simple manner so as to be rigid, that is to say, non-flexible in a radial direction. This enables precise guiding or support of the two machine components relative to each other.

In the case of an axial press-fit of the seal on one machine component, it is preferably retained so as to be arranged in a clamped manner in a retention groove of the seal retention structure of the machine component. Alternatively or in addition, the seal can be retained by means of a groove flank which is directed away from the side to be sealed by the groove flank being introduced to a greater or lesser extent into the adjacent material of the seal. If the groove flank is not introduced into the adjacent material of the seal, the seal can be held in position in a positionally stable manner by means of auxiliary elements, such as pins, screws and/or wall projections.

On the whole, undesirable axial displacement or rotation of the seal relative to the seal retention structure of one machine component can thereby be prevented. Furthermore, the seal can be assembled in a particularly simple manner.

In the structurally most simple case, the seal according to the invention is arranged with one of the ends thereof in the retention groove. According to the invention, the other end of the seal then forms the sealing lip. The degree of transverse or radial rigidity of the sliding guide as required for the sliding guide of the two machine components can be adjusted by means of a (transverse or) radial support of the seal in the retention groove and an appropriately selectable elasticity modulus of the material of the seal. The retention groove of one machine component may further have at least one groove flank which extends directly as far as the sealing gap in order to axially support the seal in an optimum manner and thus to counteract excessive resilience of the seal in the event of radial loading.

The end portion of the sealing lip is preferably movably in abutment with the pretensioning element. The sealing lip can thereby carry out compensation movements with respect to the two machine components, as may be necessary, for example, in the case of a relative movement of the two machine components with respect to each other. It is thereby possible, for example, for shaft impacts or eccentricity of the machine components which can be moved with respect to each other to be compensated for, without loss of the sealing function and at the same time with reduced wear of the sealing lip, in particular in the region of the sealing edge thereof. Furthermore, particularly simple assembly and maintenance of the seal arrangement is thereby achieved. The pretensioning element can thus be individually replaced where applicable with a new pretensioning element.

Of course, the seal and the pretensioning element may also be constructed in an integral manner. The pretensioning element may in particular be formed on the seal.

According to a quite particularly preferred development of the invention, the seal device has two sealing lips. According to one embodiment of the invention, the sealing lips extend away from each other in an axial direction.

The sliding guide formed by the seal can thereby be protected axially at both sides in a structurally extremely simple manner against the introduction of in particular particulate contaminants and/or discharge of lubricant from the sealing gap. This construction type is distinguished by an increased range of use and increased service-life.

According to an alternative embodiment of the invention, the sealing lips may also be arranged parallel in an axial direction (tandem seal).

According to the invention, the sealing lips may correspond to each other, in particular in terms of shape, size, material and/or material properties.

An embodiment of the invention which is particularly advantageous with high mechanical loads of the seal arrangement is distinguished in that the seal has two seal elements which each have a sealing lip. In this instance, the seal is consequently constructed as two components, that is to say, in two parts. The two seals are preferably arranged so as to be spaced apart from each other according to the invention. The two seal elements can be arranged with the ends thereof facing each other in different retention grooves of one machine element. The machine component which has the seal retention structure may in this instance have a (rigid) bearing structure for the other machine component, which structure is arranged in an axial direction between the two seal elements. In this instance, the bearing structure with respect to the sliding guide formed by the seal is preferably even more rigid, that is to say, even less flexible in the case of loading in a radial direction. Particularly precise and at the same time robust support or guiding of the two machine components relative to each other is thereby achieved. At the same time, mechanical loads of the seal or the sliding guide can thus be limited during operation in a simple manner, which is advantageous for the service-life of the seal arrangement. The bearing structure is further effectively protected from contamination by means of the seal elements of the seal which are arranged at both sides (encapsulated construction), whereby operational failures of the bearing structure during operation can on the whole be minimized.

According to the invention, the bearing structure may have at the bearing face thereof facing the other machine component at least one, preferably a plurality of, recess(es) in order to receive possible contamination which has been introduced into the sealing gap axially delimited by the two seal elements between the two machine components. The recess or recesses is/are advantageously arranged transversely relative to the movement direction of the two machine components along/about the movement axis. On the whole, operational impairment of the seal arrangement, in particular the sliding guide, can again thereby be further reduced. Owing to the recesses, particularly low-friction resistance of the bearing structure can further be achieved.

According to a preferred embodiment of the invention, the seal device comprises a viscoplastic material. The viscoplastic material is preferably a polymer material, in particular polytetrafluoroethylene (PTFE). It is thereby possible, on the one hand, to achieve sealing of the two machine components with respect to each other which withstands thermal, mechanical or even chemical influences and plain bearing of the two machine components.

According to the invention, the pretensioning element is preferably arranged in a recess, for example, a groove of one machine component. The pretensioning element can thereby be secured in the most structurally simple manner possible with respect to undesirable position change relative to one machine component. On the other hand, this affords advantages in terms of technical production since the pretensioning element simply has to be placed in the groove of one machine component when the seal arrangement is assembled.

When the cross-section and material of the pretensioning element are selected in an appropriate manner, the pretensioning of the sealing lip with respect to the other machine component, that is to say, the contact pressure of the sealing lip against the other machine component, can be adjusted in a simple manner. Of course, the pretensioning element may have a circular, oval or even polygonal cross-section shape.

The pretensioning element may in particular be constructed in an annular manner (for example, as an O-ring) and preferably comprises an elastomer, in particular a thermoplastic elastomer.

The method according to the invention for producing the seal arrangement according to the invention has the following steps: arranging the at least one pretensioning element on one machine component, preferably in a groove of one machine component, and subsequently compressing at least one seal blank with the seal retention structure of one machine component, with the seal being formed. The seal blank may in particular have a sleeve-like or annular-disc-like structure.

The invention relates to a seal arrangement having two machine components which are arranged so as to be able to be moved relative to each other along/about a movement axis and having at least one resiliently deformable seal which is retained in a press-fitting manner on a seal retention structure on one of the two machine components. The seal forms a sliding guide for the two machine components and has at least one sealing lip which is in sealing abutment with the other machine component in each case and which extends away from the seal retention structure in an axial direction. A free end portion of the sealing lip is supported by means of at least one resiliently deformable pretensioning element on one machine component in such a manner that the free end portion is in abutment with the other machine component with a defined contact pressure.

Other advantages and advantageous embodiments of the subject-matter of the invention will be appreciated from the description, the claims and the drawings. The features which have been mentioned above and those which are set out in greater detail below can also be used individually or together in any combination.

The invention is explained below in greater detail with reference to embodiments set out in the drawings.

The embodiments which are shown and described are not intended to be understood to be a definitive listing, but instead are of an exemplary character in order to describe the invention.

### BRIEF DESCRIPTION OF THE DRAWINGS

The accompanying drawings illustrate the invention. In such drawings:

FIG. 1 is a longitudinal section of a seal arrangement according to the invention having a seal which is constructed as an inner seal and which is retained on a seal retention structure of a machine component with axial press-fitting, the seal having a sealing lip which protrudes beyond the seal retention structure in an axial direction, the sealing lip being supported with the free end portion thereof by means of a resilient pretensioning element on one machine component in such a manner that it is pressed onto another machine component with a defined contact pressure;

FIG. 2 is a longitudinal section of a seal arrangement having a seal which is formed by means of two seal elements which each have a sealing lip, the seal elements each being arranged with axial press-fitting on one machine component;

FIG. 3 is a longitudinal section (FIG. 3A) of a seal arrangement having a seal which is formed by means of two seal elements, the seal elements each being retained with radial press-fitting on a machine component and a cut-out sectioned perspective view with slight structural changes (FIG. 3B);

FIG. 4 is a longitudinal section of a seal arrangement with a one-piece seal, which has two sealing lips which are directed away from each other, the seal being retained with radial press-fitting on one machine component;

FIG. 5 is a partially sectioned perspective view of a seal arrangement which has a seal which is constructed as an outer seal and which is arranged on a covering face of a machine component with radial press-fitting, the seal having sealing lips which are directed away from each other at both ends; and

FIG. 6 is a block diagram with individual method steps for producing a seal arrangement according to the invention.

### DETAILED DESCRIPTION OF THE PREFERRED EMBODIMENTS

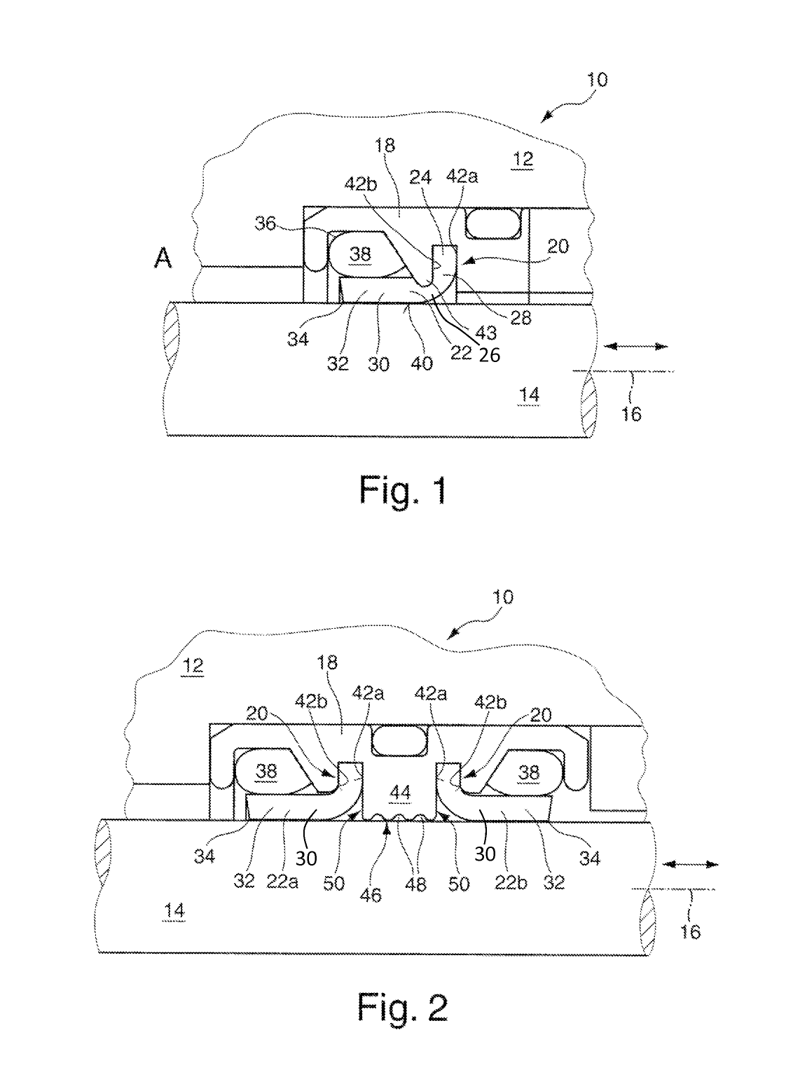

FIG. 1 shows a seal arrangement 10 having two machine components 12, 14 which are arranged so as to be able to be moved relative to each other along a movement axis 16. The machine component 12 is in this instance constructed by way of example as a cylinder and the machine component 14 is constructed as a piston which is arranged so as to be able to be moved back and forth in the cylinder. The machine component 12 has a cartridge-like seal insert 18 of a substantially rigid, in this instance metal, material. The seal insert 18 has a seal retention structure 20 which is constructed as a retention groove and in which a seal 22 is retained with axial press-fitting with a terminal securing portion 24. The securing portion 24 is connected by means of a bent seal portion 26 to a sealing lip 30 which extends longitudinally in an axial direction 28. The sealing lip 30 extends away from the seal retention structure 20 of the machine component 12 in an axial direction and protrudes in an axial direction beyond the seal retention structure 20. A free end portion 32 of the sealing lip 30 is provided with a seal edge 34. The sealing lip 30 faces towards the side A to be sealed.

As shown in FIG. 1, the free end portion 32 of the sealing lip 30 covers a groove 36 which is arranged in the sealing insert 18 and which in this instance is annular and in which a pretensioning element 38 is arranged. The free end portion 32 of the seal 22 is in movable abutment with the pretensioning element 38 and is thereby resiliently supported on the first machine component 12. In the embodiment shown in this instance, the pretensioning element 38 has a substantially circular cross-section in the unloaded state but may in principle also have a different cross-section.

The cross-section of the pretensioning element 38 is selected in relation to the groove depth of the groove 36 in such a manner that the pretensioning element 38 protrudes out of the groove 36 in the loaded state thereof shown here and presses the free end portion 32 of the sealing lip 30 with the seal edge 34 with a defined pretensioning onto the other machine component 14. The pretensioning element 38 comprises a commercially available elastomer which may have additives where applicable.

The seal 22 comprises a viscoplastic polymer material, in this instance polytetrafluoroethylene (PTFE). Of course, the polymer material of the seal may where applicable contain additives or reinforcement inserts which are not illustrated in greater detail in the drawings. [Para 40] The seal 22 forms with a sealing lip portion which axially adjoins the seal retention structure 20 a plain bearing 40 which is rigid (substantially non-flexible) in the radial direction for the two machine components 12, 14 which can be moved relative to each other. A groove flank 42a of the retention groove facing away from the sealing lip 30 protrudes, in order to axially support the sealing lip 30 with respect to the other groove flank 42b of the retention groove, radially further in the direction towards the machine component 14. As shown in FIG. 1, the groove flank 42b is introduced into the material of the seal 22 together with a wall projection 43 which adjoins the groove flank 42b in the direction towards the side A to be sealed. The seal 22 is thereby retained in position in a positionally stable manner on the machine component 12 with respect to axial forces which act on the seal 22. The wall projection 43 may be constructed so as to be segmented in the direction of the inner periphery of the machine component 12. In this instance, the seal 22 is additionally retained on the machine component 12 in a rotationally secure manner.

FIG. 2 shows a seal arrangement 10 which substantially differs from the embodiment explained above in that the seal is formed by two individual seal elements 22a, 22b. The two seal elements 22a, 22b are retained at one end with axial press-fitting in different retention grooves 20a of the seal insert 18, respectively. The two seal elements 22a, 22b may alternatively or additionally also be retained in the grooves with radial press-fitting. The groove flanks 42b of the retention grooves 20 are not introduced in the embodiment shown in FIG. 2 into the material of the individual seal elements 22a, 22b. The seal elements 22a, 22b each have a sealing lip 30, which lips 30 are supported in the manner described above via a pretensioning element 38 on the first machine component 12. The two sealing lips 30 extend in this instance in an axial direction away from each other. The machine component 12 additionally has a bearing structure 44 which is arranged between the two seal elements 22a, 22b which are arranged so as to be spaced apart from each other. The bearing structure 44 serves to support the other machine component 14 in a manner which is highly rigid in a radial direction and is in abutment with the bearing face 46 thereof with the machine component 14. The bearing face 46 has groove-like recesses 48 which are orientated transversely relative to the movement axis and which serve to receive in particular particulate contamination which has been introduced into the sealing gap 50 during operation of the seal arrangement 10. The recesses 48 further ensure low-friction resistance of the bearing face 46.

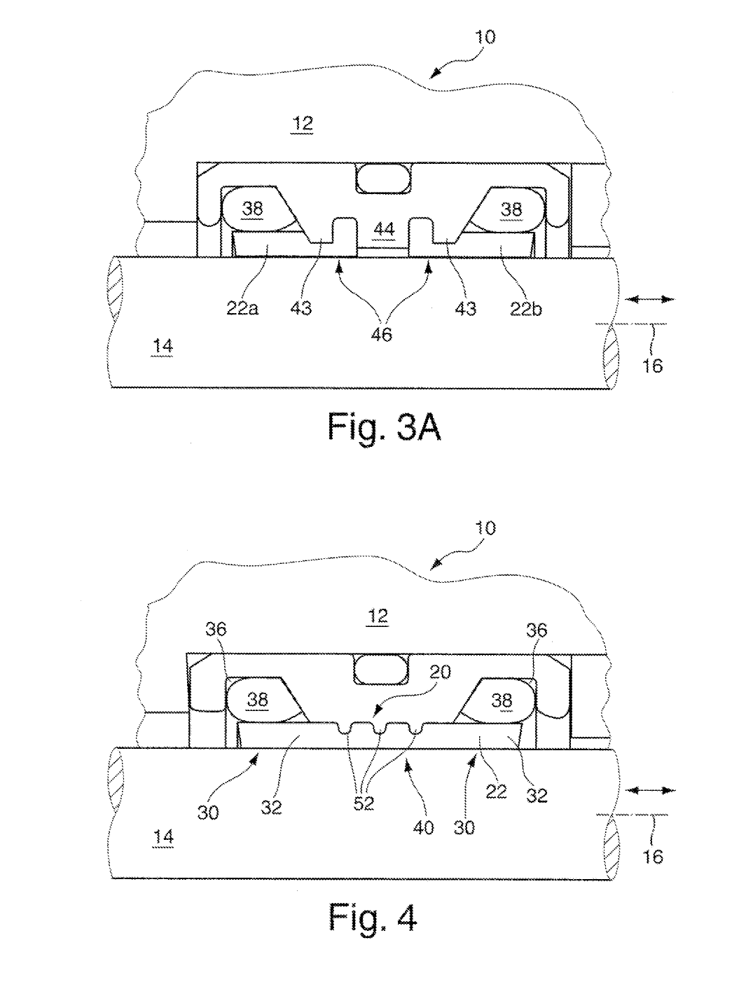

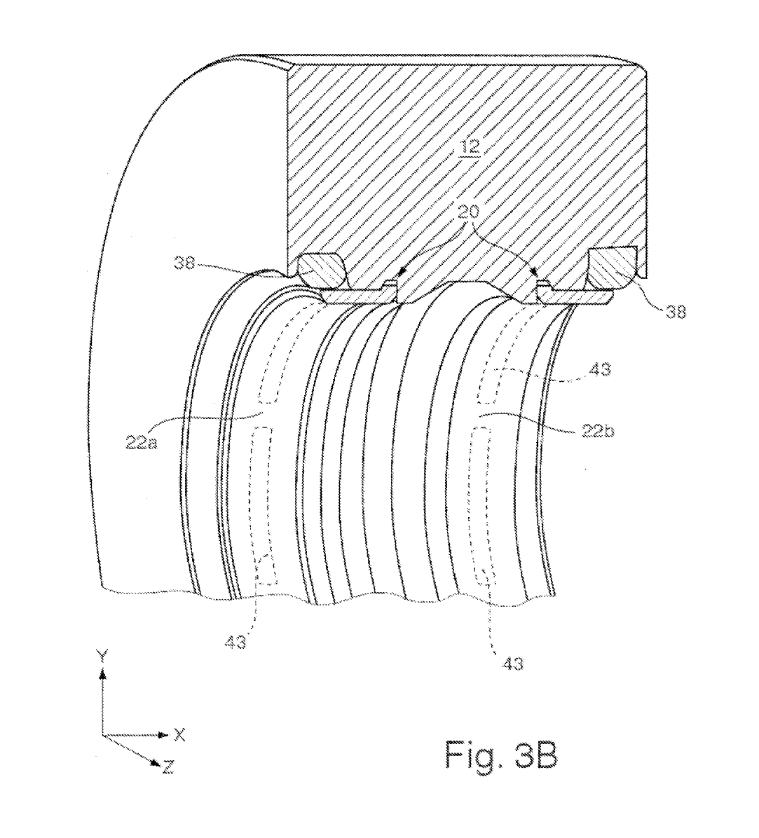

FIG. 3A is a schematic illustration of a seal arrangement 10 which substantially differs from the seal arrangement shown in FIG. 2 in that the two groove flanks 42b (see FIG. 2) and the wall projections 43 (see FIG. 3a) are introduced into the material of the seal elements 22a, 22b. The two seal elements 22a, 22b are arranged so as to be retained in a clamped manner in the retention grooves. No bearing structure is arranged between the two seal elements 22a, 22b which are arranged with axial spacing from each other.

FIG. 3B is a perspective view of the machine component 12 of the seal arrangement shown in FIG. 3A with slight structural changes together with the two seal elements 22a, 22b. The wall projections 43 which are constructed in a segmented manner in the peripheral direction of the machine component 12 can be seen clearly in this view. The wall projections 43 are covered in each case by the seal elements 22a, 22b and are therefore indicated with a dashed line.

FIG. 4 shows a seal arrangement 10 in which the seal 22 is constructed integrally as an inner seal. The seal 22 in this instance is retained substantially with radial press-fitting on the cylindrical seal retention structure 20 of the machine component 12. The seal retention structure 20 has a plurality of annular projections 52 by means of which the seal 22 which is compressed with the seal retention structure 20 is retained on the machine component 12 in an axially non-displaceable manner. In an alternative embodiment, the projections 52 may also be arranged so as to be distributed in a segment-like or point-like manner over the inner periphery of one machine component 12. The seal 22 completely covers the seal retention structure 20 in a radial direction and has two sealing lips 30 which extend in an axial direction and which face away from each other. The two sealing lips 30 each protrude in the manner already described above in an axial direction beyond the seal retention structure 20 and cover the grooves 36 at the radial side. As a result of the resilient pretensioning element 38 in each case, the free end portions 32 of the two sealing lips 30 are also in resilient abutment here with the machine component 14 with a defined pretensioning (with a defined contact pressure). A longitudinal portion of the seal 22, which portion radially covers the seal retention structure 20 and which is in abutment therewith over the complete surface, forms the sliding guide 40 which is rigid in a radial direction for the two machine components 12, 14.

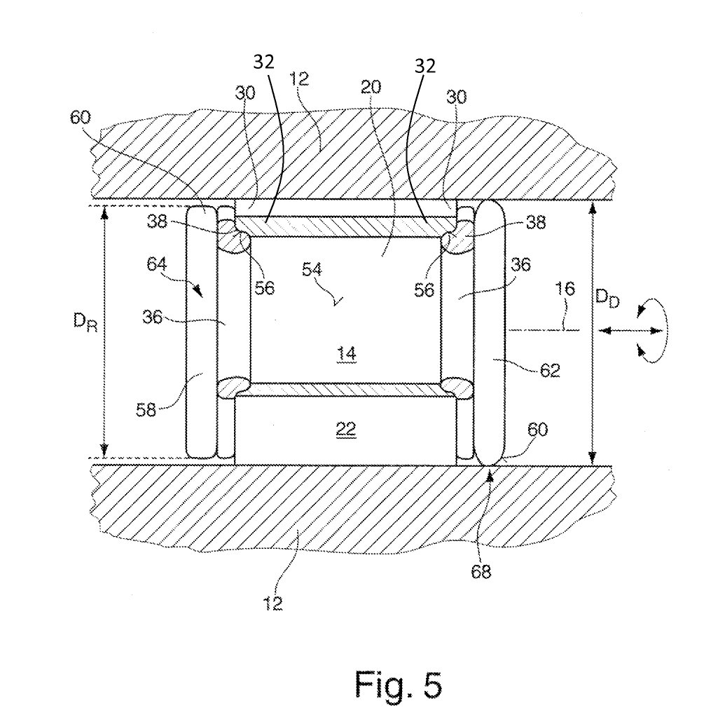

FIG. 5 shows a seal arrangement 10, which substantially differs from the seal arrangement according to FIG. 3 in that the seal 22 is arranged with radial press-fitting in the manner of an outer seal on the machine component 14 which is constructed as a piston. The piston may, for example, be constructed as a rivet piston of an impact drilling machine which is not shown in greater detail or a hammer drill, which rivet piston is guided in the other machine component. The seal retention structure 20 of the piston is formed by the outer covering face 54 of the piston and delimited in an axial direction in each case by grooves 36 of the outer covering face 54 of the machine component 14. In the grooves 36, the annular elastomer pretensioning elements 38 are arranged so as to be axially non-displaceable on the piston. In this embodiment, the seal also has two sealing lips 30, which extend axially relative to the movement axis 16 and which are pressed with the free end portions 32 thereof in each case via one of the pretensioning elements 38 with a defined contact pressure against the other machine component 12. As with the embodiments of the invention explained above, an optimized wiping and sealing action of the sealing lips 30 is thereby achieved.

The two free end portions 32 are each in movable abutment with the pretensioning elements 38 and have in each case a thickness which decreases in the direction towards the free end thereof. A contact face 56 of the sealing lips 30 which is in abutment with the pretensioning element 38 is in this instance formed in accordance with an outer contour of the pretensioning element and is in this instance constructed in a (slightly) concave manner in an axial direction. The free end portions 32 of the sealing lips 30 are thus supported in an axial direction on the pretensioning elements 38.

The seal retention structure 20 formed by the outer covering face 54 of the piston, in a manner not shown in greater detail, may have one or more recesses in which the seal 20 engages and by means of which axial displacement or rotation of the seal with respect to the piston is prevented in a reliable manner.

The piston has at one end (wiping side) an annular collar 58 having a flattened outer side 60. The annular collar has an annular collar diameter DR which is reduced in comparison with the maximum outer diameter DD of the seal 22 in order to counteract the risk of particles (for example, contamination) becoming jammed between the annular collar 58 and the second machine component 14. The piston has at the other end (for instance, facing an oil side of the seal arrangement 10) a centering collar 62 having an outer side 60 which is constructed so as to be rounded in an axial direction.

In the seal arrangements explained above by way of example, the seals 22 and the associated pretensioning elements 38 may be constructed in one piece in a manner not set out in greater detail. Furthermore, the cartridge-like seal insert 18 and the machine component which has the seal insert may be constructed in one piece. Of course, the two machine components 12, 14 of the seal arrangements 10 explained above may additionally or alternatively be able to be movable (rotatable) relative to each other about the movement axis 16 shown.

The seal arrangement 10 according to the invention is particularly suitable for use in impact drilling machines, hammer drills, shock absorbers and the like.

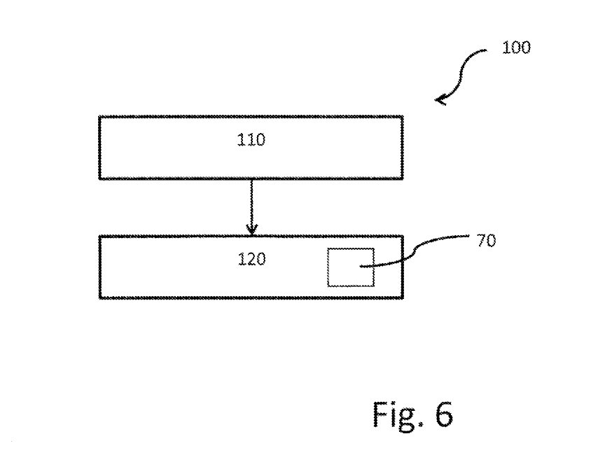

FIG. 6 is a block diagram with individual steps of the method for producing the seal arrangement according to the invention. The method 100 comprises the following steps:

Arranging 110 the at least one pretensioning element 38 on one of the machine components 12, 14 and subsequently compressing 120 at least one seal blank 70 with the seal retention structure 20 of one machine component 12, 14 with the seal 22 being formed. The compression of the seal blank can in the case of an inner seal to be formed particularly be carried out by means of a tool mandrel which is not shown in greater detail.

Although several embodiments have been described in detail for purposes of illustration, various modifications may be made to each without departing from the scope and spirit of the invention. Accordingly, the invention is not to be limited, except as by the appended claims.

What is claimed is:

1. A seal arrangement, comprising:
two machine components which are arranged so as to be able to be moved relative to each other along and/or about a movement axis, having at least one seal which comprises a viscoplastic material and which is retained in a press-fitting manner on a seal retention structure on one of the two machine components;
wherein the seal, with a sealing lip portion which axially adjoins the seal retention structure or with a longitudinal portion which radially covers the seal retention structure and which adjoins the seal retention structure in an extensive manner, forms a sliding guide for the two machine components;
wherein the seal has at least one sealing lip which is in sealing abutment with the other machine component in each case and which extends in an axial direction away from the seal retention structure, and
wherein a free end portion of the sealing lip is supported by means of at least one resiliently deformable pretensioning element on one machine component in such a manner that the free end portion is in abutment with the other machine component with a defined contact pressure.

2. The seal arrangement of claim 1, wherein the seal is retained on the seal retention structure with radial and/or axial press-fitting.

3. The seal arrangement of claim 1, wherein the free end portion of the sealing lip is in movable abutment with the pretensioning element.

4. The seal arrangement of claim 1, wherein the seal has two sealing lips which extend away from each other in an axial direction.

5. The seal arrangement of claim 4, wherein the sealing lips in a state one behind the other are directed in the same direction.

6. The seal arrangement of claim 4, wherein the seal has two seal elements which each have a sealing lip.

7. The seal arrangement of claim 6, wherein one of the machine components has a rigid bearing structure for the other machine component, which structure is arranged in an axial direction between the two seal elements.

8. The seal arrangement of claim 7, wherein the bearing structure has at the bearing face thereof at least one recess which is preferably arranged transversely relative to the movement axis.

9. The seal arrangement of claim 1, wherein the viscoplastic material is a polymer material,

10. The seal arrangement of claim 9, wherein the polymer material comprises polytetrafluoroethylene (PTFE).

11. The seal arrangement of claim 1, wherein the pretensioning element is arranged in a groove of one machine component.

12. The seal arrangement of claim 1, wherein the pretensioning element comprises an elastomer.

13. The seal arrangement of claim 1, wherein the seal retention structure is formed by a cartridge-like seal insert which is secured to one machine component.

14. The seal arrangement of claim 1, wherein the seal retention structure is formed by a cartridge-like seal insert which is releasably secured to one machine component.

15. A method for producing the seal arrangement of claim 1, further comprising the steps of:
arranging the at least one pretensioning element on one machine component; and
subsequently compressing at least one sleeve-like or disc-like seal blank within the seal retention structure of one machine component by means of a tool mandrel, with the seal being formed.

16. A seal arrangement, comprising:
a first and a second machine component arranged to be able to be moved relative to each other along and/or about a movement axis, where the first machine component is disposed through the second machine component;
a cartridge-like seal insert secured to an inside of the second machine component, the cartridge-like seal insert comprising an annular seal retention groove and an annular pretensioning element groove;
an annular seal comprising a terminal securing portion at one end and a sealing lip at the other end, wherein the terminal securing portion is disposed within the annular seal retention groove of the cartridge-like seal insert;
an annular pretensioning element disposed within the annular pretensioning element groove, where the annular pretensioning element is biased between the cartridge-like seal insert and the sealing lip; and
wherein the sealing lip is disposed between the annular pretensioning element and the first machine component.
